(19) United States
(12) Patent Application Publication
(10) Pub. No.: US 2014/0157918 A1
(43) Pub. Date: Jun. 12, 2014

(54) Electrically Driven Linear Actuator

(71) Applicants: Honda Motor Co., Ltd., Tokyo (JP); NTN Corporation, Osaka-shi (JP)

(72) Inventors: Yoshinori IKEDA, Iwata-shi (JP); Takao MIZUUCHI, Iwata-shi (JP); Takaaki OHNISHI, Wako-shi (JP); Hiroshi NAKANO, Wako-shi (JP); Arata INOUE, Wako-shi (JP)

(73) Assignees: HONDA MOTOR CO., LTD., Tokyo (JP); NTN CORPORATION, Osaka-shi (JP)

(21) Appl. No.: 13/943,951

(22) Filed: Jul. 17, 2013

(30) Foreign Application Priority Data
Aug. 27, 2012 (JP) 2012-186753

(51) Int. Cl. F16H 25/22

(52) U.S. Cl. CPC F16H 25/2204
USPC 74/89.23

(57) ABSTRACT

An electric linear actuator has a screw shaft incapable of rotating with respect to the housing. The screw shaft provides axial movement. A steel sleeve is fit into a bag like housing hole of the housing. A recessed groove is formed on the inner circumference of the sleeve and extends in a shaft direction. A locking pin, applied with metal plating, is inserted into an end of the screw shaft. The locking pin engages the recessed groove. The end of the sleeve is externally fit with a cap. The cap is fit into a base portion of the bag like housing hole of the housing.

### CROSS-REFERENCE TO RELATED APPLICATION

This application claims the benefit and priority of Japanese Application No. 2012-186753, filed Aug. 27, 2012. The disclosure of the above application is incorporating herein by reference.

### FIELD

The present disclosure relates to an electric linear actuator with a ball screw mechanism employed in electric motors for general industrial purposes and for drive units in, for example, automobiles, and, more particularly, to an electric linear actuator employed in a transmission or a parking brake of automobiles to convert rotary input from an electric motor into linear motion of a drive shaft through a ball screw mechanism.

### BACKGROUND

Electric linear actuators employed in various drive units typically use a gear mechanism that includes a trapezoidal thread, a rack and pinion, or the like. These mechanisms convert rotary motion of an electric motor into linear axial motion. The conversion mechanisms have a sliding contact portion and, thus, the power loss is large. The conversion mechanisms inevitably required an increase in size and electric power consumption of the electric motor. Accordingly, ball screw mechanisms are starting to be adopted as a more efficient actuator.

In conventional electric linear actuators, for example, a ball screw shaft, constituting a ball screw, is rotatably driven by an electric motor. The motor is supported by a housing. An output member is rotatably driven by the ball screw shaft. The output member is connected to a nut that is capable of moving in the shaft direction. The ball screw mechanism has significantly low friction. The ball screw shaft is easily rotated by a thrust load acting on the output member side. As such, the position of the output member needs to be maintained during when the electric motor is stopped.

Accordingly, breaking means, such as a worm gear, is provided to the motor, or low efficiency transmission means. Among these means, an electric linear actuator illustrated in FIG. 6 is typically known. A cylindrical housing 51, constituting this electric linear actuator, includes a cavity 51a to accommodate a ball screw mechanism and a cylinder 51b with the same diameter. A fluid inlet (not shown) and a fluid outlet 51c are in communication with the cylinder 51b.

A screw shaft 52 is connected at one end to an electric motor (not shown). The electric motor is disposed outside the housing. The screw shaft 52 extends into the cavity 51a of the housing 51. A male screw groove 52a, a cylindrical shaft 52b, and a flange 52c are formed on the outer circumferential surface of the screw shaft 52. The flange 52c is disposed between the male screw groove 52a and the cylindrical shaft 52b. An inner ring 53a, of a bearing 53, is fit into an outer circumference of the cylindrical shaft 52b. The inner side end, right end in the drawing, of the inner ring 53a abuts against the flange 52c. Furthermore, the outer side end, left end in the drawing, of an outer ring 53b of the bearing 53 abuts against a snap ring 54 that is fit into the cavity 51a of the housing 51. Accordingly, the screw shaft 52 is supported by the bearing 53 in a rotatable manner with respect to the housing 51. Thus, movement in the shaft direction is prevented. Note that an integrated spacer 55 and spring plate (buffer member) 56 are held between the inner side end of the outer ring 53b of the bearing 53 and a step 51d of the housing 51.

A cylindrical nut 57 is only rotatably supported relative to the housing 51. The nut 57 surrounds the screw shaft 52 and is formed with a female screw groove 57a on its inner circumferential surface. A plurality of balls 58 is rotatably disposed in the helical raceway formed between the two facing screw grooves 52a and 57a. The ball screw mechanism includes the screw shaft 52, the nut 57, and the balls 58.

A rectangular plate-shaped section 57b is integrally formed on the outer circumference of the nut 57. The plate-shaped section 57b juts out in the radial direction of the nut 57. The rectangular plate-shaped section 57b serves as an engaging portion and enters a guide groove 51e. The guide groove 52e has a rectangular cross-sectional shape formed along the axis direction in the inner circumferential surface of the cavity 51a of the housing 51. Thus, engagement occurs between the plate shape section 57b and with the guide groove 51e. A predetermined clearance δ is formed between each of the lateral sides, engaging faces 57c and 57c, of the rectangular plate-shaped section 57b and the respective facing lateral sides, guide faces 51f and 51f, of the guide groove 51e.

A tube 57d serves as a circulation member. The tube 57d is mounted on the flat-shaped outermost side of the rectangular plate-shaped section 57b. The tube 57d is fixed to the nut 57 with a bracket 57e, using a screw 57f. The tube 57d returns the balls 58 from one end to the other end of the helical raceway formed between the two screw grooves 52a and 57a, during operation of the ball screw mechanism.

A hollow cylindrical piston member 59, with one closed end, is mounted on the right end of the nut 57. The inside of this piston member 59 enables the screw shaft 52 to move in and out thereof. The outer circumferential surface of the piston member 59 is tightly fit into the inner circumference of the cylinder 51b of the housing 51. The piston member 59 is slidable relative to the inner circumference of the cylinder 51b. An O-ring 60 is disposed in a circumferential groove 59a formed in the vicinity of the right end of the piston member 59. The O-ring 60 prevents the fluid charged into the cylinder 51b from leaking into the cavity 51a side by passing between the piston member 59 and the cylinder 51b (see Japanese Unexamined Patent Application Publication No. 2006-233997

### SUMMARY

In the above conventional electric linear actuator 50, the rectangular plate-shaped section 57b is integrally formed with the nut 57. Thus, when it made from a steel material, while wear resistance and strength can be obtained, the issue of high cost related to the integral structure is still left unresolved. Furthermore, when the housing 51 is formed of aluminum alloy, in order to reduce weight, wear resistance and strength become insufficient leading to a need for improvement. Still further, when the housing 51 is formed from aluminum alloy and in a case where control is lost due to system error or the like, the ball screw, being pushed by the load, comes into contact with the inner wall of the housing 51 by inertial force. In this case, there is a risk of malfunction due to lack of strength.

On the other hand, the mass of the electric linear actuator 50 itself increases when the housing 51 is made from a steel material in order to increase the strength of the housing 51. Accordingly, measures need to be taken to increase the rigidity of the mounting unit that supports the actuator. Furthermore, when the electric linear actuator is to be used for automobiles, wear resistance and smooth operating performance are required. Thus, the sliding resistance during linear motion needs to be as small as possible.

The present disclosure has been made in view of the above problems encountered by conventional techniques. Thus, it is an object of the disclosure to provide an electric linear actuator that reduces damage and wear of the housing. Further, it provides an electric linear actuator that improves durability and strength. Thus, it improves reliability while having reduced weight.

In order to achieve the above object, an electric linear actuator according to a first aspect of the disclosure includes an aluminum alloy housing. An electric motor is mounted on the housing. A speed reduction mechanism is configured to transmit torque of the motor through a motor shaft. A ball screw mechanism is configured to convert rotational motion of the motor into linear axial motion of a drive shaft through the speed reduction mechanism. The ball screw mechanism includes a nut that is rotatably supported by a support bearing mounted on the housing. Axial movement of the nut is prevented. The nut has a helical screw groove formed on its inner circumference. A screw shaft is inserted inside the nut. A plurality of balls is positioned between the grooves. The screw shaft is coaxially integrated with the drive shaft. A helical screw groove is formed on an outer circumference of the shaft. The shaft groove corresponds to the helical screw groove of the nut. The shaft is supported so that it is incapable of rotating with respect to the housing. Thus, the shaft is only capable of axial movement. A steel sleeve is configured to prevent rotation of the screw shaft. It is fit into a bag like housing hole of the housing. The end of the sleeve is externally fit with a cap. The cap is fit into a base portion of the bag like housing hole of the housing.

The electric linear actuator includes the speed reduction mechanism that is configured to transmit torque of the motor. The ball screw mechanism is configured to convert rotational motion of the motor into linear axial motion of the drive shaft through the speed reduction mechanism. The ball screw mechanism includes the nut. The nut is rotatably supported through a pair of support bearings mounted on the housing. The nut is incapable of axial movement. The nut has the helical screw groove formed on its inner circumference. The screw shaft is inserted inside the nut. A plurality of balls is positioned between the grooves. The screw shaft is coaxially integrated with the drive shaft. The helical screw groove is formed on its outer circumference and corresponds to the helical screw groove of the nut. The shaft is incapable of rotating with respect to the housing. Thus, the shaft is only capable of axial movement. The steel sleeve is configured to prevent rotation of the screw shaft. The sleeve is fit into the bag like housing hole of the housing. The end of the sleeve is externally fit with the cap. The cap is fit to a base portion of the bag like housing hole of the housing.

The sleeve may preferably be fastened to the bag like housing hole of the housing through a screw portion. Thus, the screw shaft can be reliably prevented from rotating.

A relief may be formed at the base portion of the bag like housing hole of the housing. Thus, machining error can be tolerated and assembly precision can be improved. Furthermore, in the case of a failure, a damper effect can be expected and, thus, reliability is improved.

A recessed groove, extending in a shaft direction, may be formed on the inner circumference of the sleeve. A locking pin may be inserted into an end of the screw shaft and may engage with the recessed groove. Wear-resistant metal plating may be applied to a surface of the locking pin. Thus, wear can be suppressed over a long period of time.

Wear-resistant metal plating may be applied to a surface of the recessed groove of the sleeve. Thus, wear can be suppressed over a long period of time.

Metal plating with different materials may be preferably applied to the recessed groove and the locking pin. Thus, adhesion of the recessed groove and the locking pin during sliding is prevented.

The cap may be formed from a steel plate to have a U shape in cross section. The cap may have a base portion that abuts the base portion of the bag like housing hole of the housing. The cap may have a collar portion that is formed from a rim portion of the base portion of the cap bent into a ring shape. A chamfer of the collar portion may include a plurality of rounded portions having arc surfaces with a plurality of radii of curvature. Thus, in a state where the screw-fastened portion of the sleeve and the screw shaft abut against the cap, the axial force created by the cap abutting against the base portion of the bag like housing hole of the housing can relieve the stress created in the corner portion of the cap.

The screw portion may be provided to the base portion side of the bag like housing hole. Thus, in the screw-fastened portion of the housing and the sleeve, which have different linear expansion coefficients relative to temperature increases, a change in axial force due to temperature increase can be suppressed.

A plurality of recesses may be formed at the end of the bag like housing hole of the housing. A caulking portion prevents rotation of the sleeve. The caulking portion is formed towards the recesses by plastic deformation in the outside diameter portion of the end face of the sleeve. Thus, in the operation environment of the actuator body, especially in the high-temperature range, the caulking portion can prevent the screw from being unfastened even in a case where the screw-fastened portion of the screw of the housing and the sleeve, which have different linear expansion coefficients, is in a loosen state. Thus, reliability is improved.

An electric, linear actuator according to the present disclosure includes an aluminum alloy housing. An electric motor is mounted on the housing. A speed reduction mechanism is configured to transmit torque of the motor through a motor shaft. A ball screw mechanism is configured to convert rotational motion of the motor into linear axial motion of a drive shaft through the speed reduction mechanism. The ball screw mechanism includes a nut that is rotatably supported through a support bearing mounted on the housing. The nut is prevented from having axial movement. The nut has a helical screw groove formed on its inner circumference. A screw shaft is inserted inside the nut, with a plurality of balls therebetween. The screw shaft is coaxially integrated with the drive shaft. The screw shaft has a helical screw groove formed on its outer circumference that corresponds to the helical screw groove of the nut. The screw shaft is incapable of rotating with respect to the housing. Thus, the screw shaft is only capable of axial movement. A steel sleeve is configured to prevent rotation of the screw shaft. The sleeve is fit into a bag like housing hole of the housing. The end of the sleeve is externally fit with a cap. The cap is fit into a base portion of the bag like housing hole of the housing. Thus, an electric linear actuator can be provided where the screw shaft does not directly come into contact with the housing. Thus, this reduces damage and wear of the housing. An electric linear actuator can be provided that improves durability and strength and, thus, improves reliability while having reduced weight.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal sectional view of an exemplary embodiment of an electric linear actuator.

FIG. 2 is a longitudinal sectional view illustrating an actuator body of FIG. 1.

FIG. 3 is an enlarged sectional view of the essential parts illustrating an intermediate gear of FIG. 1.

FIG. 4 is an enlarged sectional view of the essential parts illustrating a modification of FIG. 3.

FIG. 5 is an enlarged sectional view of the essential parts illustrating a cap fitting section of FIG. 1.

FIG. 6(a) is a longitudinal sectional view of a conventional electric linear actuator.

FIG. 6(b) is a cross-sectional view of FIG. 6(a) cut away along the line VI-VI.

### DETAILED DESCRIPTION

An electric linear actuator includes an aluminum alloy housing. An electric motor is mounted on the housing. A speed reduction mechanism is configured to transmit torque of the motor through a motor shaft. A ball screw mechanism is configured to convert rotational motion of the motor into linear axial motion of a drive shaft through the speed reduction mechanism. The ball screw mechanism includes a nut rotatably supported through a support bearing mounted on the housing. The nut is incapable of axial movement. The nut has a helical screw groove formed on its inner circumference. A screw shaft is inserted inside the nut with a plurality of balls between the screw shaft and the nut. The screw shaft is coaxially integrated with the drive shaft. The screw shaft has a helical screw groove formed on its outer circumference that corresponds to the helical screw groove of the nut. The screw shaft is supported so that it is incapable of rotating with respect to the housing and so as to be capable of axial movement. Furthermore, a steel sleeve is fit into a bag like housing hole of the housing. A recessed groove, extending in a shaft direction, is formed on the inner circumference of the sleeve. A locking pin, with metal plating, is inserted into an end of the screw shaft. The locking pin engages the recessed groove. The end of the sleeve is externally fit with a cap. The cap is fit into a base portion of the bag like housing hole of the housing.

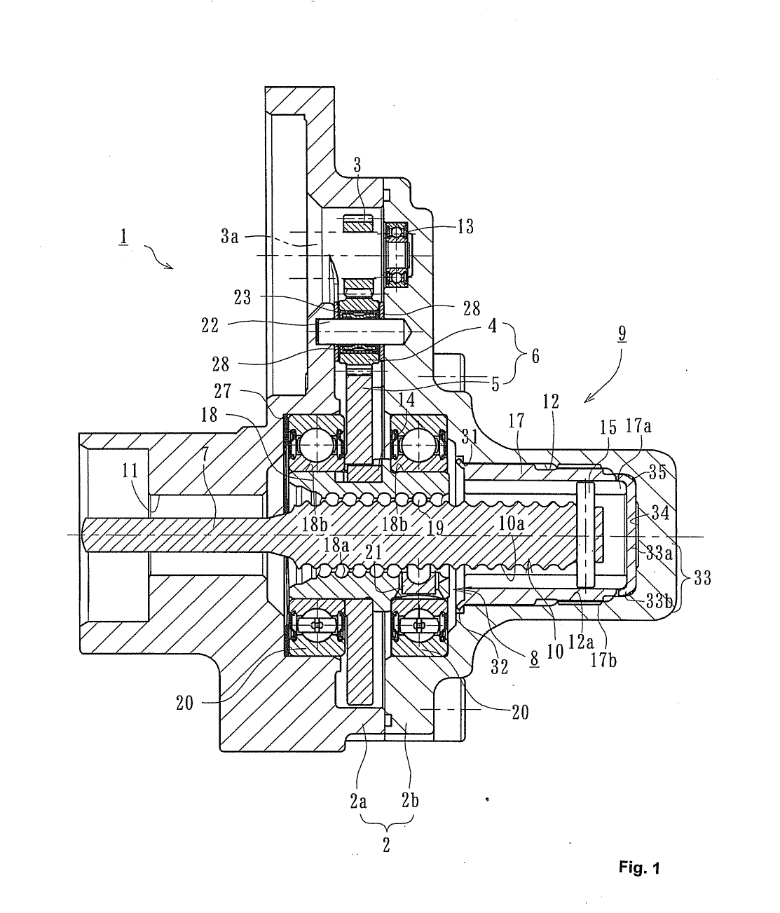

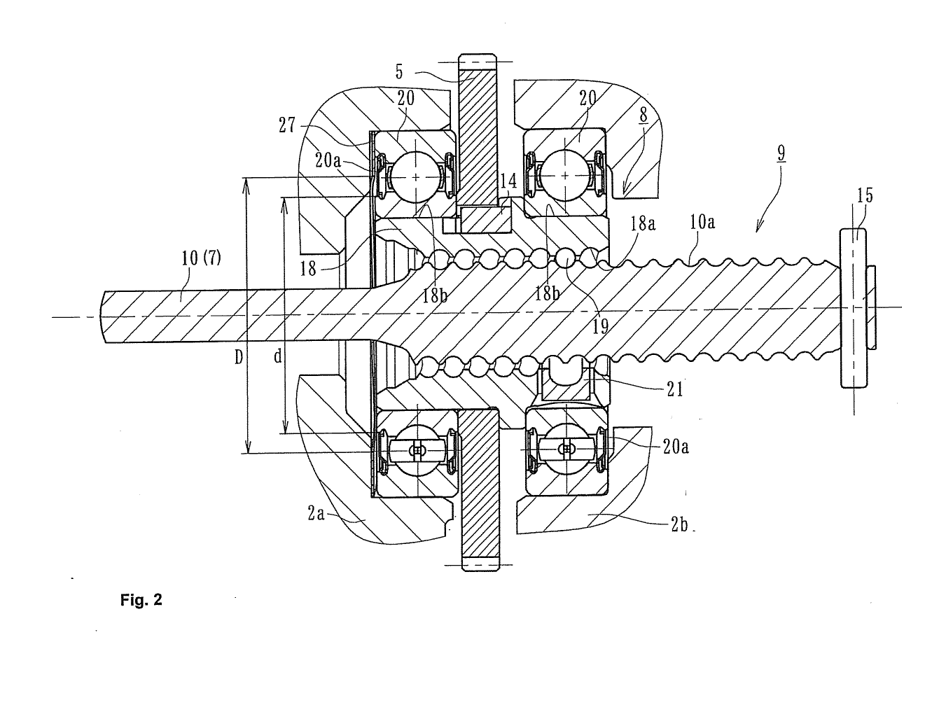

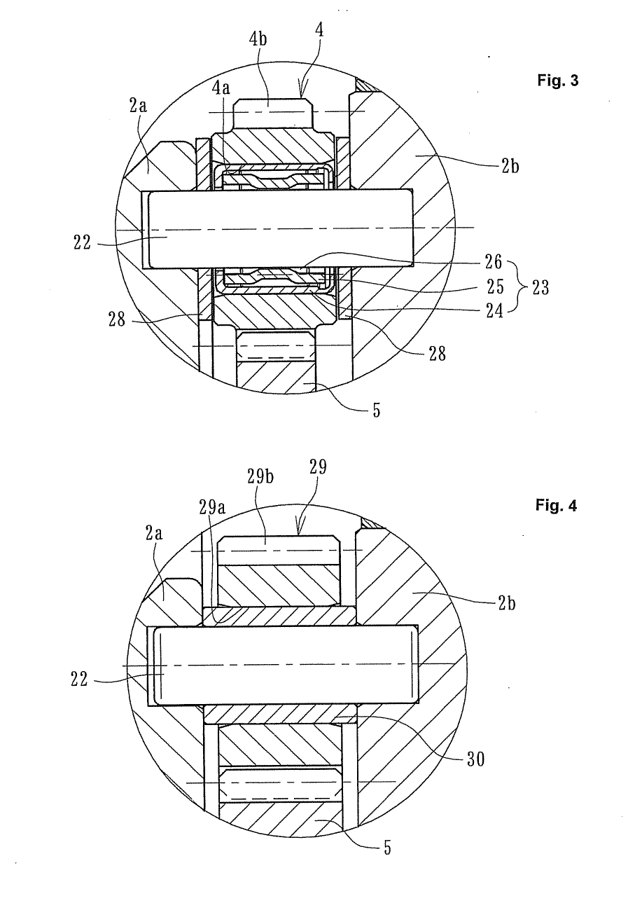

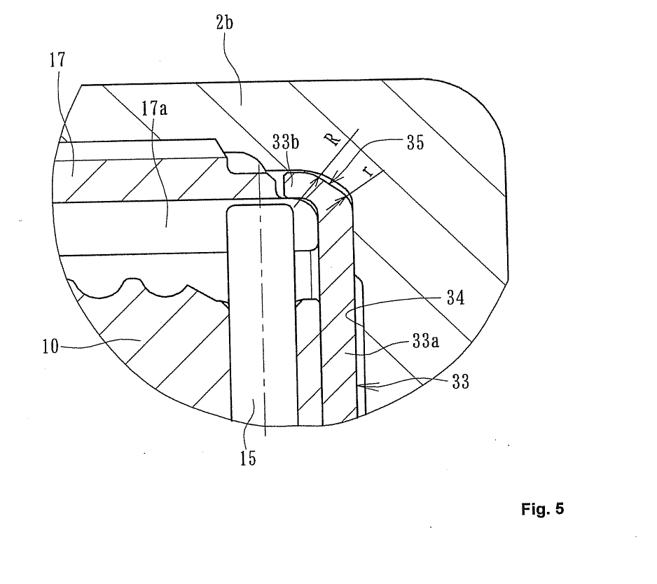

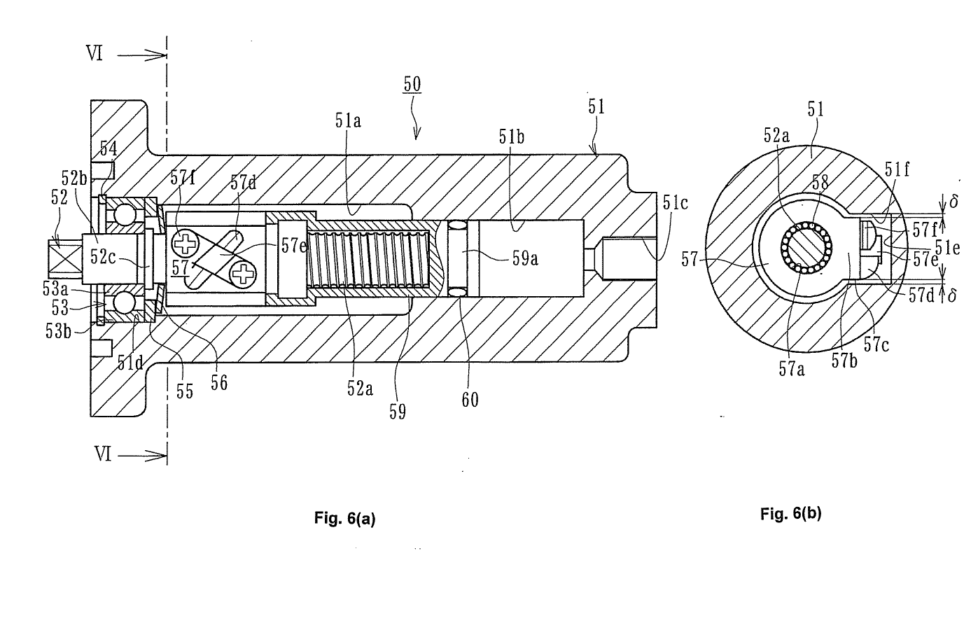

Exemplary embodiments of the present disclosure will be described in detail below with reference to the drawings. FIG. 1 is a longitudinal sectional view illustrating an exemplary embodiment of an electric linear actuator according to the present disclosure. FIG. 2 is a longitudinal sectional view illustrating an actuator body of FIG. 1. FIG. 3 is an enlarged sectional view of the essential parts illustrating an intermediate gear of FIG. 1. FIG. 4 is an enlarged sectional view of the essential parts illustrating a modification of FIG. 3. FIG. 5 is an enlarged sectional view of the essential parts illustrating a cap fitting section of FIG. 1.

As shown in FIG. 1, an electric linear actuator 1 includes a cylindrical housing 2. An electric motor (not shown) is mounted on the housing 2. A speed reduction mechanism 6 includes an intermediate gear 4 that meshes with an input gear 3 mounted on a motor shaft 3a of the electric motor. An output gear 5 meshes with the intermediate gear 4. A ball screw mechanism 8 is configured to convert rotary motion of the electric motor into linear axial motion of a drive shaft 7 through the speed reduction mechanism 6. An actuator body 9 is equipped with the ball screw mechanism.

The housing 2 is made of aluminum alloy, such as A6063TE, ADC12, or the like. The housing 2 includes a first housing portion 2a and a second housing portion 2b that abuts against the end face of the first housing 2a. The first housing portion 2a and the second housing portion 2b are integrally fixed by fixing bolts (not shown). The electric motor is mounted on the first housing 2a. Bag like housing holes 11 and 12, configured to house a screw shaft 10, are formed in the abutting portion of the first housing portion 2a and the second housing portion 2b.

The input gear 3 is mounted on the end of the motor shaft 3a of the electric motor. The input gear 3 is press fit in such a manner that the input gear 3 is relatively non-rotational. The motor shaft 3a is rotatably supported by the rolling bearing 13. The bearing 13 is a deep groove ball bearing mounted on the second housing portion 2b. The output gear 5 meshes with the intermediate gear 4, which is a spur gear. The output gears 5 is integrally fixed, through a parallel key 14, to a nut 18 included in the ball screw mechanism 8 to be described later.

The drive shaft 7 is integrally formed with the screw shaft 10 that is included in the ball screw mechanism 8. A locking pin 15 is inserted into one end (right end in the drawing) of the drive shaft 7. A sleeve 17, described later, is fastened to the bag like housing hole 12 of the second housing 2b. Additionally, the locking pin 15 of the screw shaft 10 engages recessed grooves 17a and 17a. The grooves 17a, 17a are formed in the shaft direction at a position facing the circumferential direction of the sleeve 17. Thus, the screw shaft 10 is non-rotationally supported and is only capable of axial movement.

As illustrated in an enlarged manner in FIG. 2, the ball screw mechanism 8 includes the screw shaft 10 and the nut 18. The nut 18 is externally inserted onto the screw shaft 10 with the balls 19 disposed between the screw shaft 10 and the nut 18. A helical screw groove 10a is formed on the outer circumference of the screw shaft 10. The nut 18 has a helical screw groove 18a formed on the inner circumference of the nut 18 that corresponds to the screw groove 10a of the screw shaft 10. Multiple balls 19 are rollably received between these screw grooves 10a and 18a. Further, the nut 18 is rotatably supported through two support bearings 20 and 20. Movement of the nut in the shaft direction is prevented with respect to the housings 2a and 2b. A member 21, that constitutes a circulation member, connects the screw groove 18a of the nut 18 and allows the multiple balls 19 to perpetually circulate.

The cross-sectional shape of each of the screw grooves 10a and 18a may be a circular-arc shape or a gothic-arc shape. The cross-sectional shape of each of the screw grooves 10a and 18a is formed in a gothic-arc shape. This enables the contact angle with the balls 19 to be set large and the axial gap to be set small. Accordingly, the rigidity against axial loads becomes large and it is possible to suppress the occurrence of vibration.

The nut 18 is formed of case hardening steel, such as SCM415 or SCM420. Hardening treatment is carried out by vacuum carburizing quenching on the surface of the nut 18 to have a hardness in the range of 55 to 62 HRC. Accordingly, buffing and the like for removing scale after the heat treatment can be omitted. Thus, contribution to cost reduction can be made. The screw shaft 10 is formed of medium carbon steel, such as S55C, or of case hardening steel, such as SCM415 or SCM420. Hardening treatment is carried out by induction hardening, or carburizing and quenching on the surface of the screw shaft 10 to provide a hardness in the range of 55 to 62 HRC.

The output gear 5, constituting the speed reduction mechanism 6, is integrally fixed to the outer circumferential surface 18b of the nut 18. Two support bearings 20 and 20 are press fit, with a predetermined interference, on both sides of the output gear 5. Thus, axial position deviation of the support bearings 20 and 20 and the output gear 5 can be prevented when a thrust load is exerted from the drive shaft 7. Each of the two support bearings 20 and 20 includes a sealed deep groove ball bearing mounted with shield plates 20a and 20a at both ends. Because of this, lubricating grease filled inside the bearing is prevented from leaking to the outside. Also, abrasion powder or the like is prevented from entering into the bearing from the outside.

In the present exemplary embodiment, each support bearing 20, that rotatably supports the nut 18, includes a deep groove ball bearing with the same specification. Accordingly, the above-described thrust load from the drive shaft 7 and the radial load exerted through the output gear 5 can both be undertaken. Further, check work for preventing assembly errors during the assembly process can be simplified and assembly work can be facilitated. Note that, herein, a deep groove ball bearing with the same specification refers to one where the inside diameter, the outside diameter, and the width of the bearing, the size and the number of the rolling elements, the gap inside the bearing, and the like are the same.

Among the pair of support bearings 20 and 20, one of the support bearings 20 is mounted on the first housing 2a through a washer 27, constituted by a ring-shaped elastic member. This washer 27 is a wave washer that is formed by press working an austenitic stainless steel plate (JIS SUS304 or the like) that has high strength and high wear resistance, or a cold-rolled steel plate (JIS SPCC or the like) which has been subjected to anti-corrosive treatment. The washer 27 is formed in such a manner that the inside diameter D of the washer 27 is larger than the outer diameter d of the inner ring of the support bearing 20. Thus, axial rattle of the pair of support bearings 20 and 20 can be eliminated and a smooth rotation performance can be obtained. The washer 27 only abuts against the outer ring of the support bearing 20 and does not interfere with the inner ring that becomes a turning wheel. Thus, even when the nut 18 is pushed against the first housing 2a, upon occurrence of a reverse thrust load, increase of frictional force caused by abutting of the inner ring of the support bearing 20 against the housing 2a is prevented. Accordingly, a locked state is reliably averted.

Now, description will be given of the intermediate gear 4, constituting the speed reduction mechanism 6. As illustrated in FIG. 3, a gear shaft 22 is inserted into the first and second housings 2a and 2b. The intermediate gear 4 is rotatably supported by this gear shaft 22 through the rolling bearing 23. Among the ends of the gear shaft 22, if the end on the first housing portion 2a side is press fit, for example, then, fitting of the end on the second housing portion 2b side is loose. Thus, it will be possible to secure a smooth rotation performance while tolerating misalignment (assembly error). In the present exemplary embodiment, the rolling bearing 23 is a so-called shell type needle roller bearing. It includes an outer ring 24 made from a pressed steel plate that is press-fit into the inside diameter 4a of the intermediate gear 4. A plurality of needle rollers 26 are rollably accommodated in the outer ring 24 through a cage 25. As such, the electric linear actuator can be readily available and cost can be reduced.

Ring-shaped washers 28 and 28 are each mounted on the corresponding one of the two sides of the intermediate gear 4. This prevents the intermediate gear 4 from coming into direct contact with the first and second housings 2a and 2b. Here, the intermediate gear 4 is formed in such a manner that the width of the tooth 4b is smaller than the face width. Accordingly, it is possible to reduce the contact area with the washers 28. Thus, the frictional resistance during rotation can be suppressed and a smooth rotation performance can be obtained. Each washer 28 is a flat washer. They are formed by press working an austenitic stainless steel plate that has high strength and high wear resistance, or a cold-rolled steel plate which has been subjected to anti-corrosive treatment. Note that, other than the above, the washer 28 may, for example, be formed from brass or sintered metal, or thermoplastic synthetic resin, such as polyamide (PA) 66 that is filled with a predetermined amount of fibrous reinforcing material such as glass fiber (GF).

The width of the rolling bearing 23 is set to be smaller than the face width of the intermediate gear 4. Accordingly, it is possible to prevent the sides of the bearing from being worn away or being deformed due to friction. Accordingly, a smooth rotation performance can be obtained.

FIG. 4 illustrates an exemplary modification of FIG. 3. The gear shaft 22 is inserted into the first and second housing portions 2a and 2b. An intermediate gear 29 is rotatably supported by the gear shaft 22 through a slide bearing 30. In the present exemplary embodiment, the tooth 29b is formed so that the width of a tooth 29b is the same as the face width of the intermediate gear 29. The slide bearing 30 is press fit into an inside diameter 29a of the intermediate gear 29. The slide bearing 30 includes an oil retaining bearing (NTN product name: BEARPHITE) made of porous metal with fine graphite powder added thereto. Additionally, the width of the slide bearing 30 is set to be larger than the face width of the intermediate gear 29. This prevents the intermediate gear 29 from coming into contact with the first and second housing portions 2a and 2b and from being worn away. This allows the frictional resistance during rotation to be suppressed and a smooth rotation performance to be obtained. This occurs without the mounting of the washers, and, further, decreases the number of parts used and reduces cost. Note that, other than the above, the slide bearing 30 may be formed of thermoplastic polyimide resin that makes injection molding possible, for example.

As illustrated in FIG. 1, the sleeve 17 is fastened to the bag like housing hole 12 of the second housing portion 2b. The sleeve 17 supports the screw shaft 10 so that the screw shaft 10 is non-rotational while moving in the axial direction Specifically, a female screw 12a is formed in the bag like housing hole 12 of the second housing portion 2b. A male screw 17b, to be threaded to this female screw 12a, is formed in the outer circumference of the sleeve 17. By rotating and advancing the sleeve 17 towards the base portion of the bag like housing hole 12, the female screw 12a and the male screw 17b are engaged and the sleeve 17 is fastened to the second housing 2b.

Regarding this sleeve 17, medium carbon steel, such as S55C, or case hardening steel, such as SCM415 and SCM420 is formed into a cylindrical shape by a cold forging method. Recessed grooves 17a and 17a, that penetrates through and extends in the axis direction, is formed in the inner circumference of the sleeve 17 so as to face each other. Metal plating, such as electroless nickel plating, is applied on the surface of this recessed groove 17a. On the other hand, metal plating, such as hard chrome plating, is also applied on the surface of the locking pin 15, that engages with the recessed groove 17a. Accordingly, wear resistance is improved and wear can be suppressed over a long period of time. Note that, other than the above, zinc plating, unichrome plating, chromate plating, nickel plating, chrome plating, Kanigen plating, and the like can be used as examples of the metal plating. Metal plating of the recessed groove 17a and the locking pin 15 is preferably performed with different materials. Thus, adhesion of the recessed groove 17a and the locking pin 15 during sliding is prevented.

In the present embodiment, a plurality of recesses 31 are equidistantly formed in the end face of the second housing portion 2b in the circumferential direction. Prevention of rotation of the sleeve 17 is performed by a caulking portion 32. The caulking portion 32 is oriented towards the recesses 31. The caulking portion 32 is formed by plastic deformation in the outside diameter portion of the end face of the sleeve 17.

In the present embodiment, the female screw 12a of the second housing portion 2b and the male screw 17b of the sleeve 17 are provided at the base portion side of the bag like housing hole 12. Accordingly, in the screw-fastened portion of the second housing portion 2b and the sleeve 17, which have different linear expansion coefficients relative to temperature increase, change in axial force due to temperature increase can be suppressed.

In the operational environment of the actuator body 9, especially in the high-temperature range, the caulking portion 32 can prevent the screw from being unfastened even in the case where the screw-fastened portion of the screw of the second housing portion 2b and the sleeve 17, which have different linear expansion coefficients, is in a loosen state. Thus, reliability is improved.

Here, the sleeve 17 does not directly abut against the base portion of the second housing portion 2b. The sleeve 17 is fastened through a cap 33. That is, the cap 33 is externally fit to the end of the sleeve 17. The integral cap 33 and the sleeve 17 are fit into the base portion of the second housing portion 2b. By manufacturing the sleeve 17 and the cap 33 separately, the processability of the recessed groove formed in the sleeve 17 is improved. Thus, the groove (penetrating groove) can be formed with high precision.

It is possible to provide an electric linear actuator so that the screw shaft 10 does not directly come into contact with the bag like housing hole 12 of the second housing portion 2b. Thus, damage and wear of the second housing portion 2b is reduced. Additionally, durability and strength are increased and, thus, reliability is improved while weight is reduced. Cap 33 is formed such that it has a substantially U-shaped cross section. It is formed by press working an austenitic stainless steel plate or a cold-rolled steel plate that has been subjected to anti-corrosive treatment. The cap 33 includes a base portion 33a and a collar portion 33b. The collar portion 33b is formed from a rim portion of this base portion 33a bent into a ring shape.

A relief (recess) 34 is formed at the base portion of the second housing portion 2b. The base portion 33a of the cap 33 abuts the recess 34. Accordingly, machining error can be tolerated and assembly precision can be improved. Additionally, in the case of failure, a damper effect can be excepted and, thus, reliability is improved.

The cap 33 is fit to the base portion of the second housing portion 2b. As illustrated in an enlarged manner in FIG. 5, a chamfer 35, of the collar portion 33b, is fit to the base portion of the second housing portion 2b. The chamfer includes a plurality of rounded portions having two types of arc surfaces with radii of curvature R and r. Accordingly, in a state where the screw-fastened portion of the sleeve 17 and the screw shaft 10 abut against the cap 33 as shown in FIG. 5, the axial force created by the cap 33 abutting against the base portion of the second housing portion 2b can relieve the stress created in the corner portion of the cap 33.

The electric linear actuator according to the present disclosure is employed in electric motors for general industrial purposes and drive units of, for example, automobiles. The electric linear actuator can be applied to electric linear actuators provided with a ball screw mechanism that is configured to convert rotary, input from an electric motor, into linear motion of a drive shaft through the ball screw mechanism.

As described above, while description has been given of the exemplary embodiments of the present disclosure, the present disclosure is not limited to these exemplary embodiments in any way. The description is exemplary and explanatory only and it is understood that various other embodiments can be carried out within the scope and spirit of the present disclosure. The scope of the present disclosure is described in their description of the claims and includes the equivalents and various modifications within the scope and spirit of the claims.

What is claimed is:

1. An electric linear actuator, comprising:
an aluminum alloy housing;
an electric motor mounted on the housing;
a speed reduction mechanism configured to transmit torque of the electric motor through a motor shaft;
a ball screw mechanism configured to convert rotational motion of the electric motor into linear axial motion of a drive shaft through the speed reduction mechanism;
the ball screw mechanism including:
a nut rotatably supported through a support bearing mounted on the housing and supported against axial movement, the nut has a helical screw groove formed on its inner circumference,
a screw shaft is inserted inside the nut with a plurality of balls between the nut and screw shaft, the screw shaft is coaxially integrated with the drive shaft, the screw shaft has a helical screw groove formed on an outer circumference that corresponds to the helical screw groove of the nut, the screw shaft is supported to be incapable of rotating with respect to the housing, the screw shaft moves axially,
a steel sleeve prevents rotation of the screw shaft, the sleeve is fit into a bag like housing hole in the housing, the end of the sleeve is externally fit with a cap, the cap is fit into a base portion of the bag like housing hole of the housing.

2. The electric linear actuator according to claim 1, wherein the sleeve is fastened to the bag like housing hole of the housing through a screw portion.

3. The electric linear actuator according to claim 1, wherein a relief is formed at the base portion of the bag like housing hole of the housing.

4. The electric linear actuator according to claim 1, wherein a recessed groove is formed on an inner circumference of the sleeve, the recess groove extends in a shaft direction, a locking pin is inserted into an end of the screw shaft, the locking pin engages the recessed groove, and wear-resistant metal plating is applied to a surface of the locking pin.

5. The electric linear actuator according to claim 4, wherein wear-resistant metal plating is applied to a surface of the recessed groove of the sleeve.

6. The electric linear actuator according to claim 4, wherein metal plating of different materials is applied to the recessed groove and the locking pin.

7. The electric linear actuator according to claim 1, wherein the cap is formed from a steel plate with a U shape cross section, the cap having a base portion that abuts against the base portion of the bag like housing hole of the housing and a collar portion that is formed from a rim portion of the base portion of the cap bent into a ring shape, and a chamfer of the collar portion includes a plurality of rounded portions having arc surfaces with a plurality of radii of curvature.

8. The electric linear actuator according to claim 1, wherein the screw portion is provided on the base portion side of the bag like housing hole.

9. The electric linear actuator according to claim 1, wherein a plurality of recesses are formed at the end of the bag like housing hole of the housing and the sleeve is prevented from rotating by a caulking portion formed towards the recesses by plastic deformation in the outside diameter portion of the end face of the sleeve.
